(19) United States
(12) Patent Application Publication
(10) Pub. No.: US 2014/0150761 A1
(43) Pub. Date: Jun. 5, 2014

(54) DRIVE SYSTEM FOR A MOTOR VEHICLE

(71) Applicants: Wilhelm Blumendeller, Freiberg (DE); Thomas Bleile, Stuttgart (DE)

(72) Inventors: Wilhelm Blumendeller, Freiberg (DE); Thomas Bleile, Stuttgart (DE)

(21) Appl. No.: 14/110,021

(22) PCT Filed: Feb. 28, 2012
(86) PCT No.: PCT/EP2012/053304

§ 371 Date: Jan. 24, 2014

(30) Foreign Application Priority Data
Apr. 5, 2011 (DE) 10 2011 006 756.6

(51) Int. Cl. F02D 41/00

(52) U.S. Cl. CPC F02D 41/005
USPC 123/676

(57) ABSTRACT

A drive system for a motor vehicle, having an internal combustion engine, an air and exhaust gas system, which includes at least one throttle, an exhaust gas recirculation system, which is in fluidic connection with the air and exhaust gas system at two connecting points, and a measuring device, which is designed to detect an atmospheric pressure, to detect a gas pressure at a measuring point within the air and exhaust gas system, and to ascertain a differential pressure as a function of the gas pressure and the atmospheric pressure, the measuring point being fluidically situated between the throttle and the internal combustion engine and in a region of one of the connecting points.

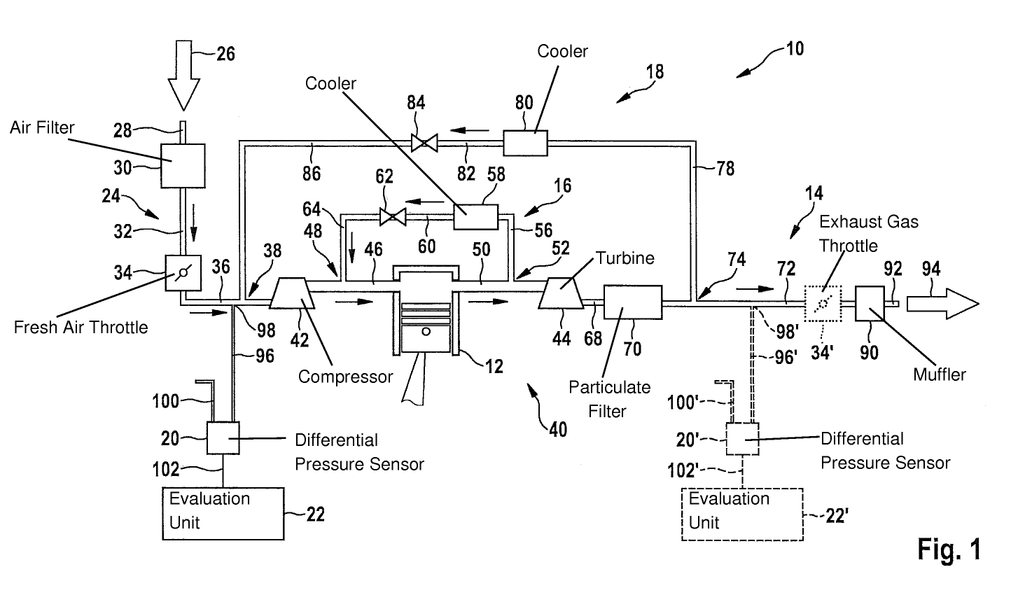

### FIELD OF THE INVENTION

The present invention relates to a drive system for a motor vehicle, having an internal combustion engine, an air and exhaust gas system, which includes at least one throttle, an exhaust gas recirculation system, which is in fluidic connection with the air and exhaust gas system at two connecting points, and a measuring device, which is designed to detect an atmospheric pressure, to detect a gas pressure at a measuring point within the air and exhaust gas system, and to ascertain a differential pressure as a function of the gas pressure and the atmospheric pressure, the measuring point being fluidically situated between the throttle and the internal combustion engine and in a region of one of the connecting points.

The present invention further relates to a method for operating a drive system for a motor vehicle, having an internal combustion engine, an air, and exhaust gas system, which includes a throttle, an exhaust gas recirculation system, which is in fluidic connection with the air and exhaust gas system at two connecting points. This method involves detecting an atmospheric pressure; detecting a gas pressure within the air and exhaust gas system, the gas pressure being fluidically detected between the throttle and the internal combustion engine and in a region of one of the connecting points; and—ascertaining a differential pressure as a function of the gas pressure and the atmospheric pressure.

### BACKGROUND INFORMATION

In the field of drive systems for motor vehicles which include an internal combustion engine, it is generally known to provide an exhaust gas recirculation system. These systems are used to lower emissions. Optimal control of the exhaust gas recirculation is essential for achieving emissions values prescribed by law.

The exhaust gas recirculation system withdraws exhaust gas from an air and exhaust gas system of the drive system at a connecting point. This connecting point is thus designed as a withdrawal point and is fluidically located downstream from the internal combustion engine. The exhaust gas is conducted through a cooler in the exhaust gas recirculation system, where it is cooled. The exhaust gas recirculation system further includes a recirculation throttle, which may control a mass flow of exhaust gas in the exhaust gas recirculation system. To regulate the mass flow, a differential pressure is ascertained, which is generated by the throttle. Based on the differential pressure, it is possible to determine the mass flow and adapt it by setting the throttle.

Two types of exhaust gas recirculation systems are known, these being one exhaust gas recirculation in a low-pressure region and one exhaust gas recirculation in a high-pressure region of the air and exhaust gas system.

If the drive system does not include a turbocharger, the entire air and exhaust gas system is typically designed as a low-pressure region. If the drive system includes a turbocharger, this turbocharger defines the high-pressure region and the low-pressure region. The high-pressure region is the region of the air and exhaust gas system in which air or exhaust gas is compressed by the action of the turbocharger. The low-pressure region is then present in the part of the air and exhaust gas system which is located outside the turbocharger.

Today, both types of exhaust gas recirculation systems are used in parallel in drive systems having a turbocharger.

In the case of exhaust gas recirculation in the high-pressure region, the differential pressure may be ascertained very easily and precisely since large pressure differences occur, which may be easily detected by sensors.

In the case of exhaust gas recirculation in the low-pressure region, the pressure differences are small, so that a detection of the pressure difference is made more difficult. Exact detection of the pressure difference is thus necessary since the mass flow in this exhaust gas recirculation responds with high sensitivity to changes in the pressure difference.

It is therefore known to measure this pressure difference with a suitable differential pressure sensor. For this purpose, an exhaust gas pressure is detected at a first measuring point in the region of the withdrawal point upstream from the recirculation throttle. In addition, another exhaust gas pressure is detected at a second measuring point in a region within the exhaust gas recirculation system downstream from the recirculation throttle. The differential pressure sensor ascertains the pressure difference automatically by measuring the two pressures relative to one another. The differential pressure sensor has a suitable sensor system for this purpose. Due to the relative detection, this sensor system is able to utilize its measuring range well. In addition, there is the option of conducting an offset adaptation when a mass flow is zero.

However, the drawback is that very high temperatures may be present at the measuring points due to the hot exhaust gas, which may result in damage to the sensor system. To protect the differential pressure sensor, complex piping is required in the region of the withdrawal point, the piping being intended to protect the sensor system from damage due to the impact of heat.

### SUMMARY

It is an object of the present invention to provide an alternative approach for detecting the pressure difference in the exhaust gas recirculation system, the approach allowing economical detection of the pressure difference while maintaining the measurement quality.

The object is achieved by a drive system and by a method of the type mentioned at the outset.

The present invention is based on the finding that the pressure difference in the exhaust gas recirculation system in a low-pressure region essentially depends on the atmospheric pressure and the gas pressure between the throttle and the internal combustion engine. A relative pressure between these two pressures may thus be measured, whereby advantageously a measuring range of the measuring device is optimally utilized. It is not necessary to measure absolute pressures. This ensures high measuring accuracy.

The atmospheric pressure may be detected directly in an engine compartment. This may be done by an “open” terminal of the measuring device, for example. It is advantageous that no measuring point within the air and exhaust gas system is required for the atmospheric pressure, and the corresponding measuring point, including the piping, known from the related art may be saved. This results in an economical detection of the differential pressure.

The gas pressure is additionally measured at a measuring point which is thermally not critical since it conducts only relatively cool gas. In other words, a relatively low temperature is present at the measuring points, so that damage to the measuring device due to the impact of heat is avoided. This, in turn, means that complex piping may be saved, whereby the design complexity is further reduced. The differential pressure may thus be detected even more economically.

The internal combustion engine may be either a diesel engine or a gasoline engine.

The air and exhaust gas system includes two parts, these being an air supply unit and an exhaust gas discharge unit. The air supply unit conducts fresh air from the surroundings to the internal combustion engine. One of the connecting points of the exhaust gas recirculation system is designed as a supply point, which is situated in the air supply unit. Recirculated exhaust gas is mixed with fresh air at the supply point. Thereafter, this mixture is conducted to the internal combustion engine.

The exhaust gas recirculation system discharges exhaust gas from the internal combustion engine to the surroundings and for this purpose typically includes purification elements, such as a particulate filter and/or a catalytic converter as well as a muffler. One of the connecting points of the exhaust gas recirculation system is designed as a withdrawal point, which is situated in the exhaust gas discharge unit. Exhaust gas is withdrawn at the withdrawal point and conducted to the supply point through the exhaust gas recirculation system.

According to one particularly preferred specific embodiment, the throttle is a fresh air throttle, and one of the connecting points is designed as a supply point, which is situated between the fresh air throttle and the internal combustion engine.

In this specific embodiment, the measuring point and the throttle are fluidically situated upstream from the internal combustion engine in the air supply unit. This creates a pressure equilibrium in the region of the measuring point resulting from a position of the throttle and pressure from the exhaust gas recirculation system.

In addition, an air filter may be inserted into the air supply unit. The pressure in the air supply unit is then also influenced by the unknown condition of the air filter (for example in the event of snow accumulation).

This arrangement has the advantage that the measuring point is situated in a cool region, which is continuously cooled by the fresh air. The heat of the supplied exhaust gas is thereby reduced, so that the measuring device is protected particularly well from the impact of heat.

At the same time, the gas pressure in the exhaust gas recirculation system (downstream from a recirculation throttle) is detected based on the equilibrium. The pressure at the withdrawal point essentially corresponds to the atmospheric pressure, so that the differential pressure here is a measure of the pressure difference in the exhaust gas recirculation system.

According to one further preferred specific embodiment, the measuring point is situated between the fresh air throttle and the supply point.

In this specific embodiment, the measuring point is fluidically situated upstream from the supply point. This has the advantage that the measuring point is situated in a particularly cool region through which primarily fresh air flows. This prevents heating of the fresh air by exhaust gas from the supply point from acting on the measuring device.

According to one further specific embodiment, the throttle is an exhaust gas throttle, and one of the connecting points is designed as a withdrawal point, which is situated between the exhaust gas throttle and the internal combustion engine.

In this specific embodiment, the measuring point and the throttle are fluidically situated downstream from the internal combustion engine in the exhaust gas discharge unit. This creates a pressure equilibrium in the region of the measuring point resulting from a position of the throttle and pressure from the internal combustion engine.

This arrangement has the advantage that the measuring point is situated in a cooler region than in the related art.

At the same time, the gas pressure in the exhaust gas recirculation system (upstream from a recirculation throttle) is detected based on the equilibrium. The pressure at the supply point here essentially corresponds to the atmospheric pressure, so that once again the differential pressure is a measure of the pressure difference in the exhaust gas recirculation system.

According to one further specific embodiment, the measuring point is situated between the exhaust gas throttle and the withdrawal point.

In this specific embodiment, the measuring point is fluidically situated downstream from the withdrawal point. This has the advantage that the exhaust gas may cool further before reaching the measuring point, whereby the impact of heat on the measuring device is further reduced.

According to one particularly preferred specific embodiment, the air and exhaust gas system includes a turbocharger, the connecting points being situated in a low-pressure region.

In this specific embodiment, the drive system includes a turbocharger having a turbine and a compressor. As mentioned at the outset, the turbocharger defines a high-pressure region and a low-pressure region in the air and exhaust gas system. The high-pressure region is situated in the flow direction between the compressor and the turbine. The low-pressure region is situated in the flow direction upstream from the compressor and downstream from the turbine.

The exhaust gas recirculation system thus extends around the turbocharger since the connecting points are situated in the low-pressure region. The use of the turbocharger causes the exhaust gas from the turbine to be particularly hot, and at the same time the pressure difference in the exhaust gas recirculation system is particularly small. The intended arrangement of the measuring point here results in particularly high protection of the measuring device from heat, while at the same time avoiding particularly complex piping. This results in particularly high economic efficiency due to the present invention.

According to one further specific embodiment, the drive system includes a control and evaluation unit, which is designed to regulate a mass flow of exhaust gas in the exhaust gas recirculation system as a function of the differential pressure.

In this specific embodiment, the mass flow in the exhaust gas recirculation system is regulated as a function of the differential pressure. For this purpose, the differential pressure is ascertained in the measuring device. The measuring device may directly ascertain the differential pressure and transmit the same to the control and evaluation unit. In further specific embodiments, the control and evaluation unit may be part of the measuring device. Individual absolute pressures may be ascertained for the gas pressure and the atmospheric pressure by suitable sensors and transmitted to the control and evaluation unit. This unit determines the differential pressure based on the absolute pressures by subtraction.

The control and evaluation unit additionally cooperates with a recirculation throttle. The recirculation throttle is situated in the exhaust gas recirculation system and thus serves as an actuator.

It is advantageous for this purpose for the control and evaluation unit, the recirculation throttle and the measuring device to form a mass flow regulator for the recirculated exhaust gas, which is very economical to use and allows very high control quality.

According to one further specific embodiment, the measuring device is a differential pressure sensor.

In this specific embodiment, a differential pressure sensor is used as the measuring device. The differential pressure sensor ascertains the differential pressure directly, so that a measuring range of the differential pressure sensor is optimally utilized. The measurement of absolute pressures is thus avoided.

It is advantageous that, by utilizing the measuring range, the measuring accuracy is increased as compared to a measurement of absolute pressures.

### BRIEF DESCRIPTION OF THE DRAWING

The FIGURE shows a schematic illustration of a drive system according to the present invention, including an internal combustion engine.

### DETAILED DESCRIPTION

The FIGURE, reference numeral 10 denotes a drive system for a motor vehicle as a whole. Drive system 10 includes an internal combustion engine 12, an air and exhaust gas system 14, a high-pressure exhaust gas recirculation system 16, and an exhaust gas recirculation system 18 in a low-pressure region. In addition, drive system 10 includes a differential pressure sensor 20 and a control and evaluation unit 22.

Air and exhaust gas system 14 includes an air supply unit 24, via which fresh air 26 is taken in. Fresh air 26 is conducted to an air filter 30 via an intake pipe 28. Fresh air 26 flows from air filter 30 through a line 32 to a fresh air throttle 34. Proceeding from fresh air throttle 34, fresh air 26 flows into a further line 36, which includes a supply point 38. Supply point 38 is an opening of exhaust gas recirculation system 18 into air supply unit 24. Exhaust gas flows from supply point 38 into line 36.

Air supply unit 24 is in fluidic connection with a turbocharger 40 via line 36. Turbocharger 40 includes a compressor 42 and a turbine 44. Compressor 42 and turbine 44 are coupled to each other for torque transmission via a shaft, which is not shown here. Compressor 40 withdraws a fresh air/exhaust gas mixture from line 36 and compresses this mixture. The compressed fresh air/exhaust gas mixture is conducted to internal combustion engine 12 via a line 46.

A high-pressure supply point 48 is situated within line 46. High-pressure supply point 48 is an opening of high-pressure exhaust gas recirculation system 16 into line 46. Additional exhaust gas flows from high-pressure supply point 48 into line 46.

After ignition, internal combustion engine 12 discharges exhaust gas via a line 50 to turbine 44. This turbine has a high-pressure withdrawal point 52. High-pressure exhaust gas recirculation system 16 extends from high-pressure withdrawal point 52 to high-pressure supply point 48. This system withdraws exhaust gas from high-pressure withdrawal point 52 via a line 56. Line 56 opens into a cooler 58, which cools the exhaust gas. Proceeding from cooler 58, the exhaust gas flows via a line 60 through a high-pressure recirculation throttle 62. In high-pressure recirculation throttle 62, a mass flow of the exhaust gas is restricted and conducted via line 64 to high-pressure supply point 48.

Proceeding from high-pressure withdrawal point 52, the exhaust gas is conducted via line 50 to turbine 44. Turbine 44 lowers the pressure of the exhaust gas, thereby driving compressor 32. Proceeding from turbine 44, the expanded exhaust gas is conducted via a line 68 to a particulate filter 70. Particulate filter 70 purifies the exhaust gas. The exhaust gas thus purified flows via a further line 72 to a withdrawal point 74. Exhaust gas recirculation system 18 extends from withdrawal point 74 to supply point 38. This system withdraws exhaust gas from withdrawal point 74 via a line 78. Line 78 opens into a cooler 80, which cools the exhaust gas. Proceeding from cooler 80, the exhaust gas flows via a line 82 through a recirculation throttle 84. In recirculation throttle 84, a mass flow of the exhaust gas is restricted and conducted via line 86 to supply point 38.

Proceeding from withdrawal point 74, line 72 continues to a muffler 90. Proceeding from muffler 90, the exhaust gas is discharged via an exhaust gas outlet 92, which is shown here in the form of a block arrow 94.

Differential pressure sensor 20 is connected via a measuring line 96 at a measuring point 98 to air supply unit 24 to detect a gas pressure in line 36. Measuring point 98 is fluidically situated upstream from supply point 38. Differential pressure sensor 20 additionally includes a second measuring line 100, which is open toward the atmospheric pressure.

The pressure is measured with the aid of appropriate sensors within differential pressure sensor 20, these sensors directly detecting a relative pressure, i.e., a differential pressure. The differential pressure thus results directly from the gas pressure at measuring point 98 and the atmospheric pressure.

Differential pressure sensor 20 is connected in terms of signaling to control and evaluation unit 22 via a signal line 102. Control and evaluation unit 22 thus receives a value of the differential pressure. Based on this value, this unit regulates a position of recirculation throttle 84, so that a mass flow regulator is formed. It is thus possible for the exhaust gas mass flow to be regulated within exhaust gas recirculation system 18.

The FIGURE shows one further specific embodiment in dotted form. The dotted elements replace the corresponding elements shown with solid lines.

In this specific embodiment, an exhaust gas throttle 34′ is provided in line 72. To determine the differential pressure, the gas pressure in line 72 is detected at a measuring point 98′ by a differential pressure sensor 20′ via a measuring line 96′, which is situated between withdrawal point 74 and exhaust gas throttle 34′. Differential pressure sensor 20′ additionally has a further measuring line 100′, which is open with respect to the atmospheric pressure.

Differential pressure sensor 20′ is connected in terms of signaling to a control and evaluation unit 22′ via a signal line 102′. Control and evaluation unit 22′ thus receives a value of the differential pressure. Based on this value, this unit regulates a position of recirculation throttle 84, so that an alternative mass flow regulator is formed. It is thus possible for the exhaust gas mass flow to be regulated within exhaust gas recirculation system 18.

The arrangement of measuring points 98 and 98′ makes it possible that the overall design of drive system 10, and in particular of air and exhaust gas system 14, is simplified, in particular that complex piping may be dispensed with. At the same time, the measuring accuracy is preserved. This, in turn, results in economical and high-precision regulation of the mass flow and design advantages.

1.-9. (canceled)

10. A drive system for a motor vehicle, comprising:
an internal combustion engine;
an air and exhaust gas system that includes at least one throttle;
an exhaust gas recirculation system in fluidic connection with the air and exhaust gas system at two connecting points; and
a measuring device adapted to:
detect an atmospheric pressure,
detect a gas pressure at a measuring point within the air and exhaust gas system, and
ascertain a differential pressure as a function of the gas pressure and the atmospheric pressure, wherein the measuring point is fluidically situated between the throttle and the internal combustion engine and in a region of one of the connecting points.

11. The drive system as recited in claim 10, wherein:
the throttle is a fresh air throttle, and
one of the connecting points is a supply point situated between the fresh air throttle and the internal combustion engine.

12. The drive system as recited in claim 11, wherein the measuring point is situated between the fresh air throttle and the supply point.

13. The drive system as recited in claim 11, wherein:
the throttle is an exhaust gas throttle, and
one of the connecting points is a withdrawal point situated between the exhaust gas throttle and the internal combustion engine.

14. The drive system as recited in claim 13, wherein the measuring point is situated between the exhaust gas throttle and the withdrawal point.

15. The drive system as recited in claim 10, wherein:
the air and exhaust gas system includes a turbocharger, and
the connecting points are situated in a low-pressure region.

16. The drive system as recited in claim 10, further comprising:
a control and evaluation unit for regulating a mass flow of an exhaust gas in the exhaust gas recirculation system as a function of the differential pressure.

17. The drive system as recited in claim 10, wherein the measuring device is a differential pressure sensor.

18. A method for operating a drive system for a motor vehicle that includes an internal combustion engine, an air and exhaust gas system that includes a throttle, and an exhaust gas recirculation system in fluidic connection with the air and exhaust gas system at two connecting points, the method comprising:
detecting an atmospheric pressure;
detecting a gas pressure within the air and exhaust gas system, the gas pressure being fluidically detected between the throttle and the internal combustion engine and in a region of one of the connecting points; and
ascertaining a differential pressure as a function of the gas pressure and the atmospheric pressure.
